(19) United States
(12) Patent Application Publication
(10) Pub. No.: US 2015/0256336 A1
(43) Pub. Date: Sep. 10, 2015

(54) End-To-End Encryption Method for Digital Data Sharing Through a Third Party

(71) Applicant: PASSWORDBOX INC., Bromont (CA)

(72) Inventors: Anton Stiglic, Brossard (CA); Daniel Robichaud, Bromont (CA); Marc-Antoine Ross, Montreal (CA); Alexandre Cormier, Montreal (CA); Richard Bruno, St. Albans, VT (US)

(21) Appl. No.: 14/430,820

(22) PCT Filed: May 17, 2013
(86) PCT No.: PCT/CA2013/050382

§ 371 Date: Mar. 24, 2015

Related U.S. Application Data
(60) Provisional application No. 61/729,358, filed on Nov. 22, 2012.

(51) Int. Cl. H04L 9/08

(52) U.S. Cl. CPC H04L 9/0822; H04L 9/0825; H04L 9/0863

(57) ABSTRACT

An end-to-end encryption method is provided for encrypting Digital Data to be made available by a Data Owner to a Data Assignee at some future point in time. The Data Owner shares the coordinates of the Data Assignee and an invitation associated the Data Assignee with a 3rd party. The Data Owner subsequently generates a Secret and encrypts the Digital Data with the Secret. The Secret is then encrypted by Data Owner with the Data Assignee's Public Key, and securely transmitted along with the encrypted Digital Data Set to the 3rd party. The Data Assignee can then obtain the encrypted Digital Data Set and the encrypted Secret from the 3rd party, decrypt the Secret with the Data Assignee Private Key and subsequently decrypt the Digital Data Set with the Secret. All secrets are maintained in a non-discoverable fashion and access to secret information can be rendered securely on multiple systems.

The present invention generally relates to user-system independent methods and processes for securing data as well as securely communicating data. More particularly, it relates to a method of end-to-end encryption without previously having a shared secret for secure digital data sharing through a third party, and wherein the process further includes a system of private/public key and symmetric key cryptography with the keys rendered non-discoverable.

### BACKGROUND

End-to-end encryption implies an uninterrupted protection of the confidentiality and integrity of transmitted data by encoding the data at its starting point and decoding it at its destination whilst safeguarding secrets, the keys, at the source and the destination points. This type of encryption involves encrypting useable data at any source with knowledge of an intended recipient, allowing the encrypted data to travel securely through vulnerable communication channels (e.g. public networks) to a recipient where such data may be decrypted based on shared secrets and algorithms.

If a sender and receiver desire to exchange data securely then each must be able to encrypt data to be sent and decrypt data that is received whilst safeguarding secrets on their systems. If the ciphertext, or secret, is a symmetric key, both will need a copy of the same key. If the ciphertext is an asymmetric key having both a public and private key pair then both parties need the other's public key.

In end-to-end encryption the fundamental challenge is how to exchange whatever keys or other information are needed so that no one else can obtain a copy. With the advent of highly secure asymmetric public/private key based algorithms, the encrypting key (i.e. the public key) could be made public, since decryption is only possible with a private decrypting key (i.e. the private key held solely by the recipient).

The problem of key exchange in a non-discoverable fashion where one or more parties may use more than one system has not yet been fully solved. In particular, it has not yet been solved for two previously unknown users attempting to communicate electronically via public networks with which they are in almost constant connection and wherein the user systems may change over time. Various prior art solutions have been proposed, however there is currently no solution to this above-mentioned problem.

U.S. Pat. No. 8,302,173 discloses the exchange of decrypted and encrypted keys, however the system is designed to transfer data between the server and the user. As such, the transaction is bilateral and not trilateral.

U.S. Pat. No. 6,636,838 discloses authentication in a single step. The subsequent exchange of keys happens between the user, who receives an encrypted message and an encrypted key, and then subsequently sends the key to the content screener for identification. If identification is met, then the message is processed. However, in this reference there is just one key involved in this communication rather than multiple keys for increased security.

U.S. Pat. No. 7,080,260 discloses methods and systems for ensuring the encryption and safety of data rather than the secure transmission of data. The system authenticates a user and a client with an encrypted data key. Following this, the system keeps the key in its system and when the user or client revisit, it authenticates them through decryption of the encrypted data key

U.S. Pat. No. 6,954,753 discloses a method wherein the data is transferred to the user by authenticating the encrypted key. The system keeps a table of the encrypted data with the identifier encrypted key. Upon entering the key the encrypted data is retrieved

US 2012/0317655 discloses a method wherein the request for data is sent from the subscriber to the system. This request is not originated by the owner of the data but rather it is the receiver who requests the system to give access to a subscriber or assignee.

U.S. Pat. No. 8,161,565 discloses a method wherein the user sends a ciphertext key to the server and the server decrypts the key and checks with the list of decrypted keys in the system to find the associated information. As such, the associated decrypted information is obtained.

U.S. Pat. No. 7,412,599 discloses a method wherein the record identifier keeps track of all changes happening by each user through the list of mapping and list of users that links the modifications to a specific user. The user authentication happens through a generated public key. When the user is authenticated, the system keeps track of every change done by the user in a record list.

Therefore, there is need for a safe future-proof method and system for end-to-end encryption between two previously unknown users attempting to communicate electronically from various systems by way of unsecured public networks.

This background information is provided to reveal information believed by the applicant to be of possible relevance to the present invention. No admission is necessarily intended, nor should be construed, that any of the preceding information constitutes prior art against the present invention.

### BRIEF SUMMARY

In at least one embodiment, the present invention provides a method of creating a symmetric encryption key and a strong key by a data owner on a first user system for sending to a third party, the method having the steps of creating at least one symmetric encryption key, the symmetric encryption key associated with a respective at least one data assignee, generating a data owner public key and data owner private key, receiving at least one data assignee public key associated with each respective at least one data assignee, encrypting the at least one symmetric encryption key with the respective at least one data assignee public key, sending at least one encrypted symmetric encryption key encrypted with at least one data assignee public key to the third party, deriving a strong key based on a master password and a set of algorithms, the master password known solely to the data owner and the set of algorithms provided solely by the third party, encrypting each at least one symmetric encryption key and a data owner private key with the strong key using a symmetric algorithm, generating a symmetric encryption set, the symmetric encryption set including each encrypted at least one symmetric encryption key and the data owner private key, sending the symmetric encryption set to the third party, and rendering at least one of the master password, the at least one symmetric encryption key, the strong key and the data owner private key non-discoverable on the first user system.

In another embodiment, the present invention provides a method of transferring secure information from a first user system to a second user system, the method having the steps of securely registering a data owner with a third party, the data owner communicating with the third party from the second user system, sending a set of algorithms from the third party to the data owner on the second user system, deriving a strong key based on a master password and a set of algorithms, the master password known solely to the data owner and the set of algorithms provided solely by the third party, sending at least an encrypted symmetric encryption key set from third party to data owner on the second user system, the encrypted symmetric encryption key set being previously encrypted with the strong key using the first user system, decrypting the encrypted symmetric encryption key set with the strong key on the second user system, rendering at least one of the master password, the strong key and the decrypted symmetric encryption key set non-discoverable on the second user system, and deleting at least one of the master password, the strong key and the decrypted symmetric encryption key set from the second user system.

In another embodiment, the present invention provides a method of rendering at least one secret key associated with a user on a user system non-discoverable, having the steps of mixing a user private key with a user public key based on a predetermined algorithm thereby producing a string, utilizing a set of algorithms to generate a strong string from the string, and encrypting each at least one secret key with the strong string and a symmetric encryption algorithm.

In another embodiment, the present invention provides a method for securely transferring digital data from a data owner to a third party, the data owner having at least one data owner system, having the steps of securely registering the data owner possessing the digital data with the third party, the data owner securely predefining to the third party at least one uniquely identifying coordinate and at least one invitation associated with at least one data assignee, the digital data being associated with the at least one data assignee, the data owner generating a data owner public and private key pair, the data owner generating at least one symmetric encryption key associated with the at least one data assignee, the data owner generating at least one shared password associated with the at least one data assignee, the data owner deriving a strong key using a master password and a set of algorithms, the data owner encrypting the at least one shared password with the at least one symmetric encryption key associated with the at least one data assignee using a symmetric algorithm, the data owner encrypting the at least one symmetric encryption key with the strong key using a symmetric algorithm, the data owner storing the encrypted shared password and encrypted symmetric encryption key and a data owner private key on the at least one data owner system, each at least one data assignee having a corresponding at least one data assignee system, sending the invitation to the at least one data assignee based on the at least one uniquely identifying coordinate, securely registering the at least one data assignee with the third party, generating by data assignee a data assignee public key and a data assignee private key, receiving at least one data assignee public key from each at least one data assignee, each at least one data assignee generating and maintaining access to a data assignee private key, sending the at least one data assignee public key to the data owner, encrypting the digital data with the shared password, encrypting the at least one symmetric encryption key with the at least one data assignee public key, receiving the encrypted at least one symmetric encryption key and the encrypted digital data at the third party, rendering at least one of the data assignee public key and the data assignee private key non-discoverable on the at least one data assignee system and rendering at least one of the shared password, the master password, the strong key, the symmetric encryption key, the owner private key and the data assignee public key non-discoverable on the at least one data owner system, and deleting at least one of the data assignee private key on the at least one data assignee system and deleting at least one of the shared password, the master password, the symmetric encryption key, the strong key and the data owner private key from the at least one data owner system.

In another embodiment, the present invention provides a method for securely transferring digital data from a third party to a data assignee, the data assignee having a data assignee system, having the steps of transferring an encrypted shared password, an encrypted symmetric encryption key and encrypted digital data to the data assignee, and decrypting the encrypted symmetric encryption key with a data assignee private key to obtain the encrypted shared password, decrypting the encrypted shared password with the decrypted symmetric encryption key and decrypting the encrypted digital data with the decrypted shared password.

In another embodiment, the present invention provides a system for securely transferring digital data from a data owner to a third party, the data owner having at least one data owner system, having registration means for securely registering the data owner possessing the digital data with the third party, the data owner securely predefining to the third party at least one uniquely identifying coordinate and at least one invitation associated with at least one data assignee, the digital data being associated with the at least one data assignee, the data owner generating a data owner public key and a data owner private key, the data owner generating at least one symmetric encryption key associated with the at least one data assignee, the data owner generating at least one shared password associated with the at least one data assignee, the data owner deriving a strong key using a master password and a set of algorithms, the data owner encrypting the at least one shared password with the at least one symmetric encryption key associated with the same data assignee using a symmetric algorithm, the data owner encrypting the at least one symmetric encryption key with the strong key using a symmetric algorithm, the data owner storing the encrypted shared password and encrypted symmetric encryption key and an owner private key on the at least one data owner system, each at least one data assignee having at least one corresponding data assignee system, communication means for sending the invitation to the at least one data assignee based on the at least one uniquely identifying coordinate, registration means for securely registering the at least one data assignee with the third party, communication means for receiving at least one data assignee public key from each at least one data assignee, each at least one data assignee generating and maintaining access to a data assignee private key, communication means for sending the at least one data assignee public key to the data owner, encryption means for encrypting the digital data with the shared password, encryption means for encrypting the at least one shared password with the at least one symmetric encryption key, encryption means for encrypting the at least one symmetric encryption key with the at least one data assignee public key, communication means for receiving the encrypted at least one symmetric encryption key and the encrypted digital data at the third party, encryption and communication means for rendering at least one of the data assignee public key and the data assignee private key non-discoverable on the at least one data assignee system and rendering at least one of the shared password, the master password, the strong key, the symmetric encryption key, the owner private key and the data assignee public key non-discoverable on the at least one data owner system, and encryption and communication means for deleting at least one of the data assignee private key on the at least one data assignee system and deleting at least one of the shared password, the master password, the symmetric encryption key, the strong key and the data owner private key from the at least one data owner system.

### DESCRIPTION OF THE DRAWINGS

The present invention will be better understood in connection with the following Figures, in which:

FIG. 1 is a flow diagram illustrating the process by which the Data Owner (DO) obtains necessary information from the Data Assignee (DA);

FIG. 2 is a flow diagram illustrating the process by which the strong key (K) is created and the symmetric encryption key (KEK) is created and stored;

FIG. 3 is a flow diagram illustrating the process of Master Password (MP) creation and strong key (K) creation and, related Set of Algorithm(s) (SOA);

FIG. 4 is a flow diagram illustrating the process of transferring secret information from one user system (S₁) to another user system (Sₘ);

FIG. 5 is a flow diagram illustrating the process of creation, encryption and storage of the Shared Password (SP);

FIG. 6 is a flow diagram illustrating the process of the transfer of Data Assignee public key (DAPuKey) to Data Owner and Data Owner encryption and storage of symmetric encryption key (KEK);

FIG. 7 is a flow diagram illustrating the process of transmitting the encrypted symmetric encryption key to Third Party Server (3PS) and decryption of secret information by Data Assignee; and

FIG. 8 is a flow diagram illustrating the process of making symmetric and asymmetric keys non-discoverable.

### DETAILED DESCRIPTION OF THE EMBODIMENTS

In at least one embodiment, there is provided a method for securely sharing a secret via a third party between a registered user of the third party and a previously unregistered user of the third party which is less cumbersome for the previously unregistered user.

The following definitions will be used throughout the following specification:

Data Owner (also referred to as the “DO”): The person or persons, service or services, that defines the party that possesses Digital Data for sharing, as will be discussed in further detail below. It is contemplated that the Data Owner can be an asset originator or owner. According to at least one embodiment of the present invention, the Data Owner may encrypt and transmit Digital Data and Digital Data Sets to a Third Party, as discussed below. The Data Owner chooses which Data Assignee will receive which Digital Data Set, where it is contemplated that the Digital Data Set can include a part or the whole of Digital Data.

Data Assignee (also referred to as the “DA”): A person, service, or party that has been defined, at any time before a trigger event, by the Data Owner. It is contemplated that the Data Assignee can be identified by both a unique name and detailed coordinates by the Data Owner, among other unique identifying characteristics that will readily be understood by the skilled person. It is contemplated that the Data Assignee can receive a portion of the Digital Data (which will be pre-encrypted), as predefined by the Data Owner in their Digital Data Set, after a trigger event that has occurred and was validated through the third party digital storage provider.

Third Party (also referred to as the “3P”): The third party digital storage provider responsible for obtaining and storing encrypted Digital Data and Digital Data Sets, and managing the interactions between the various systems, the Data Owner and the Data Assignee through communicating notices, events, invitations, among other methods of communication that will be readily understood by the skilled person. It is further contemplated that the Third Party distributes the relevant portion of the Data Owner's Digital Data (called the Digital Data Set as further discussed below) when authorized to do so. The Third Party is also responsible for the arm's length validation of the occurrence of the trigger event as defined by the criteria pre-established by Data Owner.

Third Party Server (also referred to as the “3PS”): The Third Party Server is the environment and means which carries out services of the Third Party. In at least one embodiment, it is contemplated that the Third Party Server is a cloud computing server having internet access for both the Data Owner and the Data Assignee, among other arrangements as will be readily understood by the skilled person.

Invitation: Any traceable, original and unmanipulated, electronic communication that serves as an invitation from one party to another party, such as, but not limited to an SMS code, an email link, a card holding a code, among other electronic communications that will be readily understood by the skilled person.

Digital Data (also referred to as the “DD”): Any digital information, such as but not limited to, a username plus password combination, software code, data files, digital media such as a photo, music, video, a document, text, notes, binary string, among any other digital information that will be readily understood by the skilled person.

Digital Data Set (also referred to as the “DDS”): The specific data which is any part of Digital Data pre-selected by the Data Owner which is to be solely transferred to the Data Assignee upon a trigger event related to that Digital Data Set. It is contemplated that the Digital Data may be the source of multiple Digital Data Sets that may be designated for transfer to multiple Digital Assignees, or alternatively the Digital Data Set may be completely co-extensive and coterminous with the Digital Data, among other arrangements that will be readily understood by the skilled person.

Encryption Key: A key used to encrypt a Secret, as discussed below.

Public Key (also referred to as the “PuKey”): A key generated by a Public Key Infrastructure for a destination party, that is the originator of the public key generation request, which may be shared amongst various other parties to encrypt secret information by a source party and transfer secret information from a source party to the destination party securely over public networks.

Private Key (also referred to as the “PrKey”): A key generated by a Public Key Infrastructure for a destination party which is not shared with any other party and is used solely to decrypt secret information transferred over public networks by a source party that used the public key of the destination party for encryption.

Shared Password (also referred to as the “SP”): A random-character password which is generated by a Data Owner and which is solely used in connection with one Data Assignee.

Symmetric encryption key (also referred to as the “KEK”): A random-character string used with a symmetric encryption algorithm and which is generated by a Data Owner to be solely used in connection with one Data Assignee.

∀: For all.

{ . . . }: The set containing the elements . . . .

K[S]: Using encryption algorithm(s) [ ] with encryption key K to encrypt secret information S.

Vi: Any variable V that can be indexed from 1 to some maximum integer value. The index integer here is represented by “i” but the characters j, k, l, m or n are also used below. The variable can be any capital letter(s).

In at least one embodiment, the present invention provides a novel end-to-end encryption method for digital data sharing through a Third Party, as will be described hereinafter. Although the invention is described in terms of specific illustrative embodiment(s), it is to be understood that the embodiment(s) described herein are by way of example only and that the scope of the invention is not intended to be limited thereby.

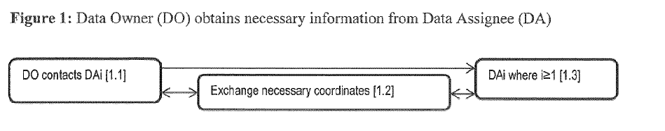

Referring to FIG. 1 which is a flow diagram illustrating at least one embodiment of the process by which the Data Owner (DO) obtains necessary and sufficient uniquely identifying information from the Data Assignee (DA), the DO contacts any (represented by the index “i”) of the DO's Data Assignees (DAi) [1.1] via any suitable communication means (e.g. phone, fax, SMS, email, etc.) and agrees on a secure means (e.g. phone, fax, SMS) to exchange any necessary and sufficient coordinates [1.2] that may be needed by a DO authorized third party (i.e. the 3PS). There must be at least one DA [1.3].

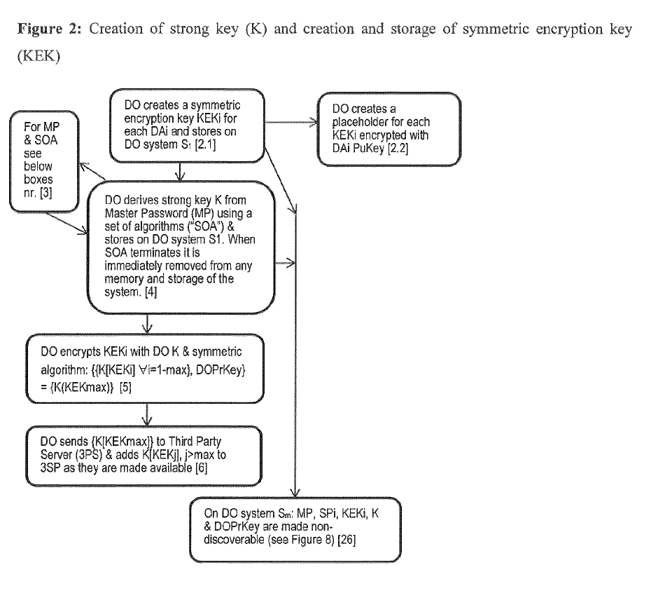

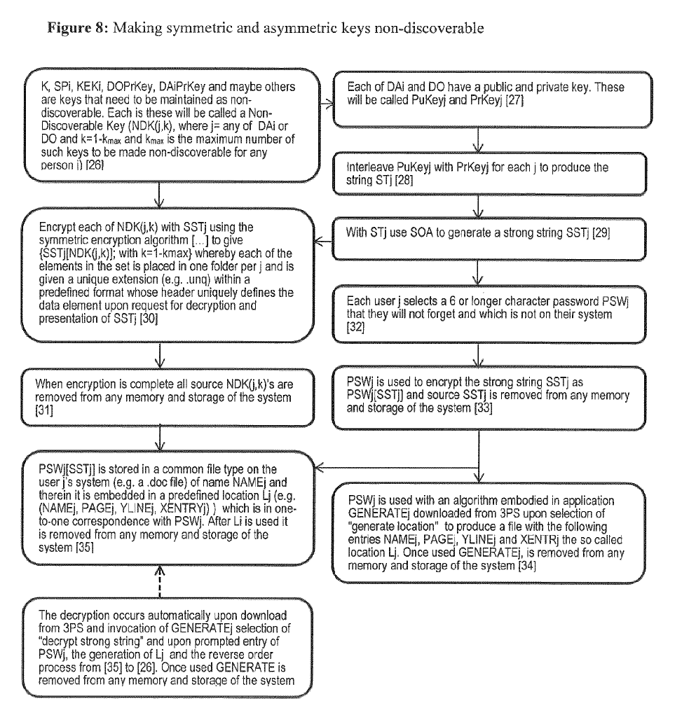

Referring to FIG. 2 which is a flow diagram illustrating at least one embodiment of the process by which a DO creates and stores, on DO's current system S₁, a symmetric encryption key (KEKi) [2.1] associated with one and only one Data Assignee, DAi, of any of DO's Data Assignees ({DAj}, j=1−max). DO then creates a placeholder on S₁ for KEKi which will be encrypted in a further process with the DAi's public key (DAiPuKey) [2.2]. On system S₁, using a set of algorithms (SOA) and a Master Password (MP) that is solely known and derived by DO from information solely known to DO, DO derives a strong key (K) which is solely available to DO [3]. When SOA terminates the algorithm is immediately removed from any memory and storage of the system. [4]. DO then encrypts each KEK (KEKi) with K using a symmetric algorithm [ . . . ] which results in K[KEKi] and the set of such results plus the DO private key DOPrKey is stored in {K[KEK1], . . . , K[KEKmax], DOPrKey}={{K[KEKi] ∀i−1−max}, DOPrKey}, which for simplicity of notation this is called {K[KEKmax])}, on S₁ [5]. DO then sends {K[KEKmax]} to the Third Party Server (3PS) and, from time to time, automatically adds any new DA encrypted symmetric encryption keys, i.e. K[KEKj] where j>max thereto as they become available [6]. On any DO system all secret keys, MP, SPi, KEKi, K and DOPrKey are made non-discoverable (see FIG. 8) [26].

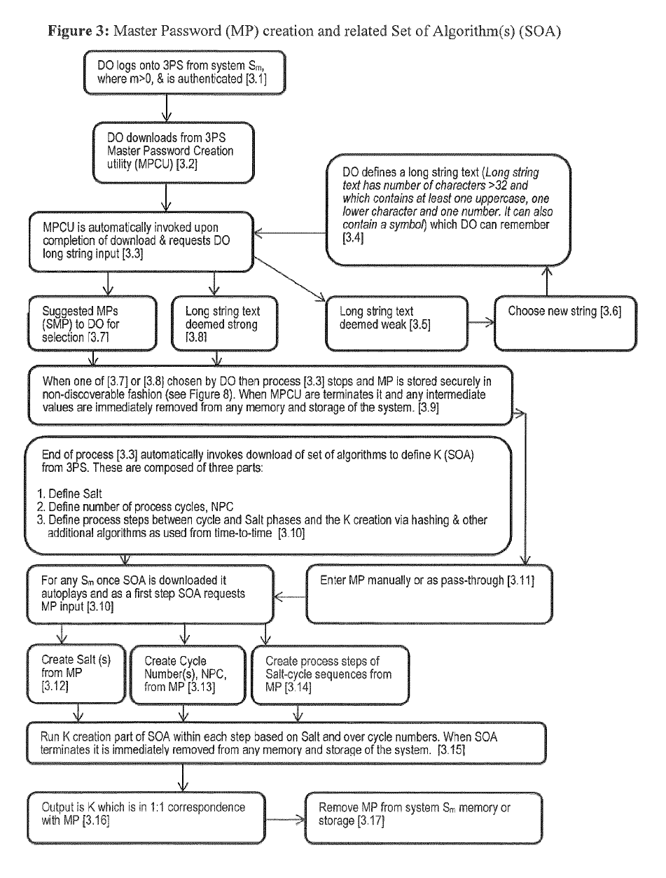

Referring to FIG. 3 which is a flow diagram illustrating at least one embodiment of the process of Master Password (MP) creation, strong key (K) creation and the use of the related Set of Algorithm(s) (SOA) which are used to assure that DO secret information is accessible on any DO system Sₘ where m>0. In this process DO logs onto 3PS from system Sₘ and is authenticated [3.1]. On system Sₘ, DO then chooses to download, from 3PS, the Master Password Creation Utility (MPCU) [3.2] which is automatically invoked upon termination of download and which requests a long string input [3.3].

In at least one embodiment, DO defines on system S₁, the first time MPCU is used, a long string input (LTI) (for example, a long string text which has a number of characters greater than 32 and which contains at least one uppercase, one lower character and one number. It can also contain one or more symbols.) and which DO can easily remember (e.g. a long text whereby page number and paragraphs from an electronic book or a website which are known to DO and are easily remembered by DO) [3.4]. This LTI is inputted, e.g. ‘Copy-Paste’ pass-through, into MPCU at [3.3]. MPCU then determines if LTI is too weak [3.5], is strong enough [3.8] and also makes suggestion(s) of one or more potential strong Master Passwords (SMP) [3.7]. If LTI is too weak then DO is requested to choose another LTI [3.6] and redo the above process from [3.4] to [3.3] to [3.7] and [3.8]. When LTI is deemed strong enough then this process stops and DO chooses either the final LTI or one of the SMP that can easily be remembered as the Master Password MP. Once DO has made this choice the MP is fixed for future use and stored securely in a non-discoverable fashion (see FIG. 8) on S₁ and subsequently, at some other point in time, on Sₘ where m>1. When MPCU terminates it and any intermediate values like LTI and SMP are immediately removed from any memory and storage of the system. [3.9].

In at least one embodiment, once MP is known, any system Sₘ where m>0 can download the set of algorithms SOA from 3PS. These algorithms are composed of three parts [3.10]:
(1) A process to define the Salt¹ ¹ A Salt is a random string of data used to modify a password hash.
(2) A process that defines the number of Salt process cycles NPC
(3) Define process steps between cycle and Salt phases and the algorithms for creating K via hashing and other algorithms.

On any Sₘ once SOA is downloaded it autoplays and its first request is for DO to input MP [3.10]. DO can input MP manually or via pass-through (e.g. via clipboard) [3.11]. SOA then creates a Salt with MP as seed [3.12], creates the number of process cycles NPC used at any stage with MP as a seed to define NPC [3.13], defines the process steps between the use of the Salt in the algorithm(s) in each cycle [3.14] and runs, at each step, the related K creation algorithm(s) therein based on hashing and other algorithms. When SOA terminates it is immediately removed from any memory and storage of the system. [3.15]. The output of this process on any system Sₘ m>0 is the strong key K which is in one-to-one correspondence with MP [3.16]. Once K is known MP is no more needed on the system since the user remembers how to obtain MP [3.17].

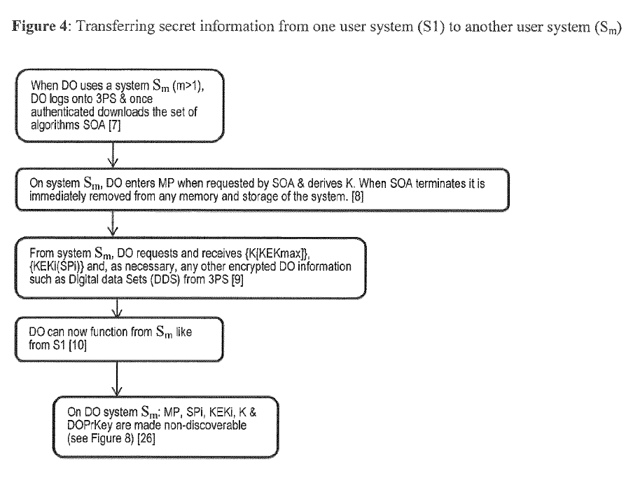

Referring to FIG. 4 which is a flow diagram illustrating at least one embodiment of the process of transferring secret information from one user system S₁ to another user system Sₘ. When DO uses a system Sₘ (m>1), which is not the first system with which DO set up an account via 3PS, DO first logs onto the 3PS and then once authenticated downloads the set of algorithms SOA [7]. DO enters the MP, from what DO knows as derived by MPCU per FIG. 3 on S₁ (i.e. steps [3.3] to [3.8]), when requested by SOA and uses SOA, per FIG. 3 steps [3.10] to [3.16], to derive K. When SOA terminates it is immediately removed from any memory and storage of the system [8]. From system Sₘ (m>1), DO requests and receives {K[KEKmax]}, {KEKi[SPi]} and, as necessary for DO operation on Sₘ, any other encrypted DO information from 3PS [9]. By decrypting {K[KEKmax]} with strong key K DO obtains on system Sₘ {{KEKi}, DOPrKey} and by decrypting {KEKi[SPi]} with KEKi DO obtains on system Sₘ {SPi} [10]. Thereafter, on any DO system all secret keys, MP, SPi, KEKi, K and DOPrKey are made non-discoverable (see FIG. 8) [26].

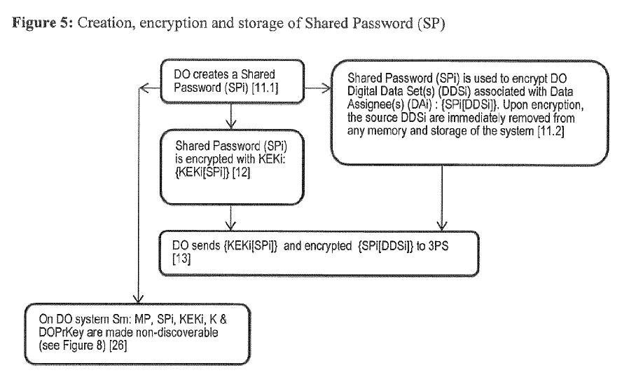

Referring to FIG. 5 which is a flow diagram illustrating at least one embodiment of the process of creation, encryption and storage of the Shared Password (SP), DO creates Shared Password(s) (SPi) or each known DAi [11.1]. The SPi is used to encrypted the Digital Data Set(s) (DDSi) associated with Data Assignee(s) (DAi) to yield the set {SPi[DDi]} and, upon encryption, the source DDSi are immediately removed from any memory and storage of the system [11.2]. Further, the Shared Password(s) (SPi) is (are) encrypted with their DAi associated KEKi to yield {KEKi[SPi]} [12]. DO then sends {SPi[DDi]} and {KEKi[SPi]} to 3PS [13] as discussed in further detail below. On any DO system all secret keys, MP, SPi, KEKi, K and DOPrKey are made non-discoverable (see FIG. 8) [26].

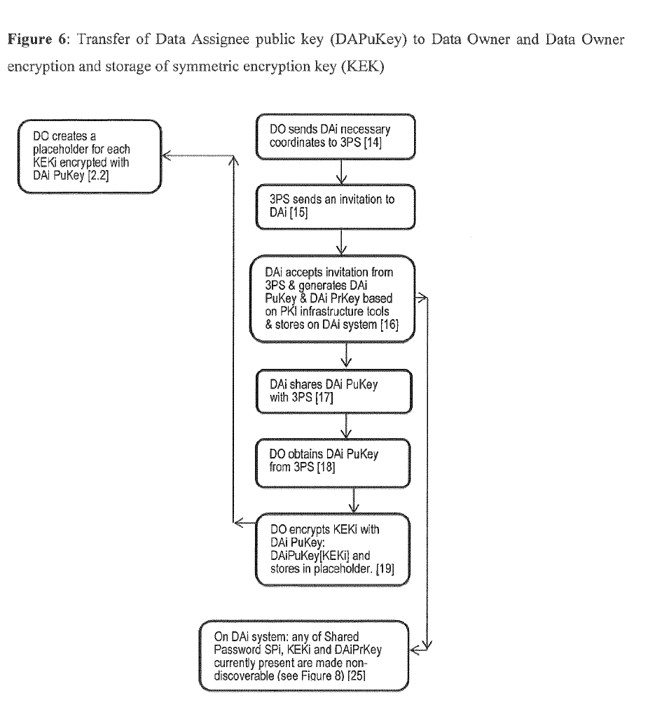

Referring to FIG. 6 which is a flow diagram illustrating at least one embodiment of the process for the transfer of the Data Assignee public key (DAPuKey) to Data Owner and Data Owner encryption and storage of symmetric encryption key (KEK). Here, after the DO creates a placeholder for each KEKi which will be encrypted with DAPuKeyi [2.2], DO sends the DAi necessary coordinates to 3PS [14]. Then 3PS sends an invitation to DAi [15]. Once DAi accepts the invitation from 3PS DAi automatically generates the DAi public key (DAiPuKey) and private key (DAiPrKey) based on the PKI infrastructure and tools and this key pair is stored on DAi system [16]. Once these keys are stored on DAi system DAi automatically shares the public key DAiPuKey with 3PS [17] and 3PS pushes the DAiPuKey to DO [18]. With DAiPuKey DO, on any DO system, can now encrypt KEKi with DAiPuKey to obtain DAiPuKey[KEKi] for each DAi and place in DO's placeholder [2.2].

On the DAi system all secret keys, such as for example Shared Password SPi, KEKi and DAiPrKey, are made non-discoverable (see FIG. 8) [25].

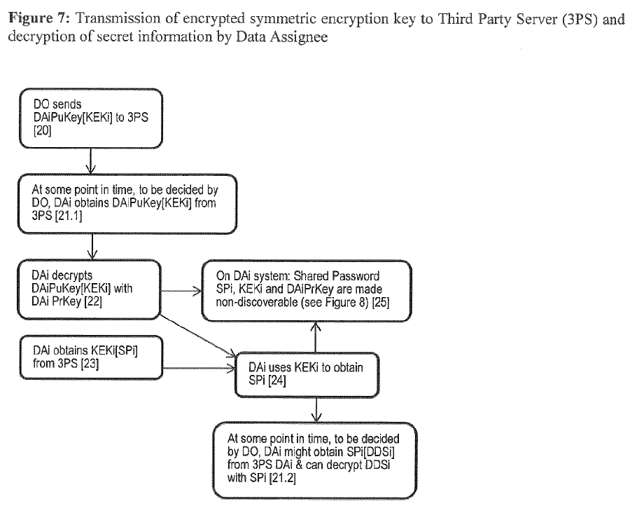

Referring to FIG. 7, which is a flow diagram illustrating at least one embodiment of the process of transmitting an encrypted symmetric encryption key to a Third Party Server (3PS) and the decryption of secret information by a Data Assignee. Here DO sends symmetric encryption key KEKi as encrypted by the DA public key DAiPuKey, i.e. DAiPuKey[KEKi], to 3PS once so encrypted [20]. At some point in time, which is to be decided by DO when DO has authorized a release to 3PS, DAi obtains DAiPuKey[KEKi] from 3PS [21.1]. When DAi obtains DAiPuKey[KEKi] from 3PS DAi decrypts DAiPuKey[KEKi] with DAi's private key DAiPrKey [22]. DAi then can obtain the encrypted Shared Secret KEKi[SPi] from 3PS [23] and decrypt this with KEKi to obtain SPi [24]. Also, at some point in time to be decided by DO when DO has authorized a release to 3PS, DAi might obtain the encrypted Digital Data Set SPi[DDSi] from 3PS and DAi can decrypt this with SPi to obtain their Digital Data Set DDSi [21.1]. On the DAi system all secret keys, such as for example Shared Password SPi, KEKi and DAiPrKey, are made non-discoverable (see FIG. 8) [25].

Referring to FIG. 8, which is a flow diagram illustrating at least one embodiment of the process of making symmetric and asymmetric keys non-discoverable and illustrating the decryption of such keys when needed, MP, K, SPi, KEKi, DOPrKey, DAiPrKey and possibly others are secret keys that need to be maintained as non-discoverable. Each is these secret keys will be called a Non-Discoverable Key NDK(j,k), where j is any of the Data Assignees (DAi) or the Data Owner (DO) and k=1−kmax where k=1 is Data Owner and kmax is the maximum number of such keys to be made non-discoverable for any Data Assignee i=j−1 [26]. Each of DA and DO have a public and private key. These are referred to as PuKeyj and PrKeyj where the j index is used as immediately above [27].

The first step is to interleave PuKeyj with PrKeyj with some pre-decided interleave factor for each j which then produces the string STj [28]. Next with STj as input one uses SOA (as already defined in FIG. 3 above) to generate a strong string called SSTj [29]. SSTj is then used to encrypt each of NDK(j,k) by using the symmetric encryption algorithm used before and referred to here as [ . . . ]. This gives {SSTj[NDK(j,k)]; with k=1−kmax} whereby each of the elements in the set is an element placed in one and the same folder for each j on, and solely on, j's system and is given a unique extension (e.g. .unq) whose structure and naming is within a predefined format with a header that uniquely defines the data element such that upon a request for decryption and presentation of SSTj the set, or an element of the set, can be decrypted automatically [30].

In at least one embodiment, when encryption is complete all of the source NDK(j,k)'s are removed from any memory or storage of the system to assure that no third party or third party program can find the unencrypted secret keys [31].

Each user j then selects a 6 character or longer password which is referred to here as PSWj. PSMj should be chosen such that user j will not forget it as it should not be saved on j's system where the encrypted secrets are stored [32].

PSWj is then used to encrypt the strong string SSTj as PSWj[SSTj] and the source SSTj is removed from any memory or storage of the system to assure that no third party or third party program can find the unencrypted secret keys. Note that for DO that PSW can be MP and for DAi that PSWi can be found by the same process as MP in FIG. 3 above [33].

This password, PSWj, is also used with an algorithm in an application called GENERATEj, download from 3PS, which upon selection of “generate location” in the invoked application called GENERATEj is used to produce a file with the following entries NAMEj, PAGEj, YLINEj and XENTRj; this is the so called location Lj [34]. PSWj[SSTj] is then stored in a common file type on the user j's system (e.g. a .doc file) of name NAMEj and therein it is embedded in a predefined location Lj (e.g. (NAMEj, PAGEj, YLINEj, XENTRYj)) which is in one-to-one correspondence with PSWj. After Li is used to store PSWj[SSTj] it and GENERATEj are removed from any memory or storage of the system to assure that no third party or third party program can find the unencrypted secret keys or the application [35]

In at least one embodiment, the decryption occurs automatically upon download from 3PS and invocation of application GENERATEj and the selection of “decrypt strong string” therein. After said selection the user j is prompted to enter PSWj which results in the generation of Lj and the reversal of the order of the process from [35] to [26]. After Lj generation by GENERATEj the application is removed from any memory or storage of the system [36].

Numerous modifications could be made to any of the embodiments described above without departing from the scope of the present invention. Further, it is obvious that the foregoing embodiments of the invention are examples and can be varied in many ways. Such present or future variations are not to be regarded as a departure from the spirit and scope of the invention, and all such modifications as would be obvious to one skilled in the art are intended to be included within the scope of the following claims.

1. A method of creating a symmetric encryption key and a strong key by a data owner on a first user system for sending to a third party; the method comprising the steps of:
creating at least one symmetric encryption key, the symmetric encryption key associated with a respective at least one data assignee;
generating a data owner public key and a data owner private key;
receiving at least one data assignee public key associated with each respective at least one data assignee;
encrypting the at least one symmetric encryption key with the respective at least one data assignee public key;
sending at least one encrypted symmetric encryption key encrypted with at least one data assignee public key to the third party;
deriving a strong key based on a master password and a set of algorithms, the master password known solely to the data owner and the set of algorithms provided solely by the third party;
encrypting each at least one symmetric encryption key and a data owner private key with the strong key using a symmetric algorithm;
generating a symmetric encryption set, the symmetric encryption set including each encrypted at least one symmetric encryption key and the data owner private key;
sending the symmetric encryption set to the third party; and
rendering at least one of the master password, the at least one symmetric encryption key, the strong key and the data owner private key non-discoverable on the first user system.

2. The method of claim 1, further comprising the step of:
deleting at least one of the at least one symmetric encryption key, the strong key and the data owner private key from the first user system;
generating at least one shared password associated with a respective at least one data assignee, each at least one shared password encrypted with a respective at least one symmetric encryption key associated with the respective at least one data assignee;
sending the encrypted shared password with the respective at least one symmetric encryption key to the third party; and
rendering the shared password non-discoverable on the first user system.

3. The method of claim 1, wherein the step of deriving a strong key based on a master password and a set of algorithms further comprises:
sending a master password creation utility from the third party to the data owner;
generating the master password based on information solely known to the data owner;
determining the relative strength of the master password;
if the password is determined to be strong, storing the master password on the first user system and rendering the master password non-discoverable on the first user system; and
if the password is determined to be weak, generating a further master password until the further master password is determined to be strong.

4. The method of claim 3, further comprising the step of:
deleting at least one of the shared password and the master password from the first user system.

5. A method of transferring secure information from a first user system to a second user system, the method comprising the steps of:
securely registering a data owner with a third party, the data owner communicating with the third party from the second user system;
sending a set of algorithms from the third party to the data owner on the second user system;
deriving a strong key based on a master password and a set of algorithms, the master password known solely to the data owner and the set of algorithms provided solely by the third party;
sending an encrypted symmetric encryption key set from third party to data owner on the second user system, the encrypted symmetric encryption key set being previously encrypted with the strong key using the first user system;
decrypting the encrypted symmetric encryption key set with the strong key on the second user system;
rendering at least one of the master password, the strong key and the decrypted symmetric encryption key set non-discoverable on the second user system; and
deleting at least one of the master password, the strong key and the decrypted symmetric encryption key set from the second user system.

6. The method of claim 5, wherein the symmetric encryption key set comprises at least one symmetric encryption key, each said at least one symmetric encryption key corresponding to a respective at least one data assignee.

7. The method of claim 5, the symmetric encryption key set further comprising a data owner private key.

8. The method of claim 5, further comprising the steps of:
sending at least one encrypted shared password from the third party to the data owner on the second user system, each at least one encrypted shared password encrypted with a respective at least one symmetric encryption key; and
decrypting the encrypted shared password with the respective at least one symmetric encryption key;
rendering the shared password non-discoverable on the second user system; and
deleting the shared password on the second user system.

9. A method of rendering at least one secret key associated with a user on a user system non-discoverable, comprising the steps of:
mixing a user private key with a user public key based on a predetermined algorithm thereby producing a string;
utilizing a set of algorithms to generate a strong string from the string; and
encrypting each at least one secret key with the strong string and a symmetric encryption algorithm.

10. The method of claim 9, wherein each encrypted at least one secret key is assigned a unique file extension.

11. The method of claim 9, wherein the step of encrypting each at least one secret key with the strong string and a symmetric encryption algorithm further comprises deleting each at least one secret key from the user system.

12. The method of claim 9, further comprising the steps of:
generating a user password;
encrypting the strong string with the user password;
storing the encrypted strong string within existing information on the user system; and
deleting the strong string from the user system.

13. A method for securely transferring digital data from a data owner to a third party, the data owner having at least one data owner system, comprising the steps of:
securely registering the data owner possessing the digital data with the third party, the data owner securely predefining to the third party at least one uniquely identifying coordinate and at least one invitation associated with at least one data assignee, the digital data being associated with the at least one data assignee; the data owner generating a data owner public key and a data owner private key, the data owner generating at least one symmetric encryption key associated with the at least one data assignee, the data owner generating at least one shared password associated with the at least one data assignee; the data owner deriving a strong key using a master password and a set of algorithms, the data owner encrypting the at least one shared password with the at least one symmetric encryption key associated with the at least one data assignee using a symmetric algorithm, the data owner encrypting the at least one symmetric encryption key with the strong key using a symmetric algorithm, the data owner storing the encrypted shared password and encrypted symmetric encryption key and a data owner private key on the at least one data owner system, each at least one data assignee having a corresponding at least one data assignee system;
sending the invitation to the at least one data assignee based on the at least one uniquely identifying coordinate;
securely registering the at least one data assignee with the third party;
generating by data assignee a data assignee public key and a data assignee private key;
receiving at least one data assignee public key from each at least one data assignee, each at least one data assignee generating and maintaining access to a private key;
sending the at least one data assignee public key to the data owner;
encrypting the digital data with the shared password;
encrypting the at least one symmetric encryption key with the at least one assignee public key;
receiving the encrypted at least one symmetric encryption key, the encrypted at least one shared password and the encrypted digital data at the third party;
rendering at least one of the data assignee public key and the data assignee private key non-discoverable on the at least one data assignee system and rendering at least one of the shared password, the master password, the strong key, the symmetric encryption key, the owner private key and the assignee public key non-discoverable on the at least one data owner system; and
deleting at least one of the data assignee private key on the at least one data assignee system and deleting at least one of the shared password, the master password, the symmetric encryption key, the strong key and the data owner private key from the at least one data owner system.

14. The method of claim 13, further comprising the step of:
transferring the encrypted at least one shared password, the encrypted at least one symmetric encryption key and the encrypted digital data to the at least one data assignee.

15. The method of claim 13, further comprising the step of:
decrypting the encrypted at least one symmetric encryption key with the data assignee private key to obtain the shared password, decrypting the encrypted at least one shared password with the symmetric encryption key and decrypting the encrypted digital data with the shared password.

16. The method of claim 13, wherein the digital data comprises at least one digital data set, each at least one digital data set corresponding to a respective at least one data assignee.

17. A method for securely transferring digital data from a third party to a data assignee, the data assignee having a data assignee system, comprising the steps of:
transferring an encrypted shared password, an encrypted symmetric encryption key and encrypted digital data to the data assignee; and
decrypting the encrypted symmetric encryption key with a data assignee private key to obtain the decrypted symmetric encryption key, decrypting the encrypted shared password with the decrypted symmetric encryption key and decrypting the encrypted digital data with the decrypted shared password.

18. The method of claim 17, wherein the digital data comprises a digital data set, the digital data set corresponding to the data assignee.

19. A system for securely transferring digital data from a data owner to a third party, the data owner having at least one data owner system, comprising:
registration means for securely registering the data owner possessing the digital data with the third party, the data owner securely predefining to the third party at least one uniquely identifying coordinate and at least one invitation associated with at least one data assignee, the digital data being associated with the at least one data assignee, the data owner generating a data owner public key and a data owner private key, the data owner generating at least one symmetric encryption key associated with the at least one data assignee, the data owner generating at least one shared password associated with the at least one data assignee; the data owner deriving a strong key using a master password and a set of algorithms, the data owner encrypting the at least one shared password with the at least one symmetric encryption key associated with the same data assignee using a symmetric algorithm, the data owner encrypting the at least one symmetric encryption key with the strong key using a symmetric algorithm, the data owner storing the encrypted shared password and encrypted symmetric encryption key and an owner private key on the at least one data owner system, each at least one data assignee having a corresponding at least one data assignee system;
communication means for sending the invitation to the at least one data assignee based on the at least one uniquely identifying coordinate;
registration means for securely registering the at least one data assignee with the third party;
communication means for receiving at least one data assignee public key from each at least one data assignee, each at least one data assignee generating and maintaining access to a private key;
communication means for sending the at least one data assignee public key to the data owner;
encryption means for encrypting the digital data with the shared password;
encryption means for encrypting the at least one symmetric encryption key with the at least one assignee public key;
communication means for receiving the encrypted at least one symmetric encryption key and the encrypted digital data at the third party;
encryption and communication means for rendering at least one of the assignee public key and the assignee private key non-discoverable on the at least one data assignee system and rendering at least one of the shared password, the master password, the strong key, the symmetric encryption key, the owner private key and the assignee public key non-discoverable on the at least one data owner system; and
encryption and communication means for deleting at least one of the data assignee private key on the at least one data assignee system and deleting at least one of the shared password, the master password, the symmetric encryption key, the strong key and the data owner private key from the at least one data owner system.

20. The system of claim 19, further comprising:
communication means for transferring the encrypted at least one shared password, the encrypted at least one symmetric encryption key and the encrypted digital data to the at least one data assignee.

21. The system of claim 19, further comprising:
decryption means for decrypting the encrypted at least one symmetric encryption key with the data assignee private key to obtain the decrypted symmetric encryption key, decrypting the encrypted at least one shared password with the decrypted symmetric encryption key and decrypting the encrypted digital data with the decrypted shared password.

22. The system of claim 19, wherein the digital data comprises at least one digital data set, each at least one digital data set corresponding to a respective at least one data assignee.
